(19) United States
(12) Patent Application Publication
(10) Pub. No.: US 2003/0219537 A1
(43) Pub. Date: Nov. 27, 2003

(54) Process for coating or plating fur, feathers, hair, thread, yarn ribbons and fabric with metal

(76) Inventor: John Frederick Betts III, Denver, CO (US)

Correspondence Address: John Betts, 1452 SOUTH ELIZABETH, DENVER, CO, 80210, US

(21) Appl. No.: 10/151,534

(22) Filed: May 21, 2002

(51) Int. Cl. B05D 5/00; B05D 3/02

(52) U.S. Cl. 427/256

(57) ABSTRACT

A process for applying a tough, durable, waterproof coating to create a metallic finish, color, and appearance on furs, feathers, hairs, yarns, threads, ribbons, and fabrics for use in fishing lures, artificial fishing flies, decorative work and clothing. Except for color and appearance, this process allows the finished product to retain its original characteristics of shape, form, behavior, and flexibility.

### SPECIFICATION

### BACKGROUND

The application of a metal coating to non-metallic materials is usually done by processes such as dipping or immersion, spraying, brushing, electro-plating, or vacuum plating. The common end result, when using these procedures is that the treated materials become stiff, unwieldy, and often brittle. For example, feathers no longer look, feel, and behave as they had before they were treated.

The effectiveness of fishing lures and artificial fishing flies is dependent upon the use of the natural physical characteristics of the materials used to make these lures and flies. These characteristics include color, markings or their absence, gloss or the lack of it, shape, behavior, and flexibility or the lack of it.

The materials are either organic such as fur, feathers, hair, or plant fiber, or non-organic such as metal tinsels, wires, and foils. There is a relatively new category of man-made materials that are neither entirely natural or metal (e.g. nylon, the rayons, polyester, polyethylene, polypropylene, and the vinyls).

The value of incorporating shiny metal into lures and flies has been known for centuries. Metal and now metal coated plastics as well have been the accepted way of adding shine and sparkle to lures and flies because, until now, there has been no way to do this with fir, feathers, and hair while retaining their natural and original shape, form, behavior, and flexibility.

### SUMMARY

The process described in this application combines, for the first time, the advantages of a metal coating with those of furs, feathers, hairs, yarns, threads, ribbons and fabrics. For the first time the shape, form, behavior, and flexibility are not compromised by the metal coating. The only noticeable difference in the processed materials is in color and the considerable increase in light reflected from the surface of the material. In some cases, if the markings on the materials are strong enough, they may still be visible through the metal coating.

Because the processed materials have the same shapes, forms, behaviors, and flexibilities, they they can be incorporated into the lures and flies with techniques that have been in common practice for 2000 thousand years.

This process creates materials that can withstand 1) full exposure to the out-of-doors for months without exhibiting noticeable change, and 2) the wear and tear of recreational and commercial angling. The range of new angling lure and fly design using materials treated with this process is beyond any present way to measure it. The extension of these materials into areas out side of angling (e.g. costumes for the entertainment industry) is considerable.

The flashing undulations of bright shiny furs, feathers, and hairs in the water or sparkling as the the lure or fly rests on the surface is spectacular—as the effect on both the fish and the fisherman.

### DESCRIPTION

1. The material to be processed is washed using any one of a number of common commercial or household laundry or dishwashing soaps or hair care products. It is then rinsed and allowed to dry.

2. When dry the material is immersed in a liquid adhesive. The adhesive is used to hold the metal in place for the next step.

3. Once the material is thoroughly soaked with adhesive, the metal is applied and hammered by hand into each piece of material. The force used must be enough to drive the metal into the desired areas, but not so much as to damage the fibers of the material.

Because the materials vary from one piece to another the force has to be adjusted throughout the entire operation. Monitoring is done by the appearance and feel of each piece. The different tools used to do this were developed over a long period of time. Which one is used is determined by the material to be processed, the metal being used, and the desired end product. The tools are modified hammers.

4. After enough metal has been forced into place, the excess is scraped off using anyone of several scrapers. Again these were made for this purpose. The basic form is that of a comb. The scrapers vary in size and character, and the one being used is determined by the material it is being used on.

5. The treated materials are then polished by placing them on top of and under a protective surface, and applying considerable heat and pressure from above and below at the same time. The ultimate feel, shape, form, flexibility, and appearance of the material determines just how mush heat and pressure and pressure are applied. Too much will crush and burn the material, while too little will have no effect. As with the plating (step 3),constant monitoring is essential.

1. I claim that this process is a new and successful way to apply a tough, durable, waterproof metal coating to furs, feathers, hairs, yarns, threads, ribbons, and fabrics for use in fishing lures, artificial fishing flies, decorative work and clothing. Except for color and appearance, this process allows the finished product to retain its original characteristics of shape, form, behavior, and flexibility.
